(19) United States
(12) Patent Application Publication
(10) Pub. No.: US 2026/0098552 A1
(43) Pub. Date: Apr. 9, 2026

(54) PRESSURE FITTING FOR MATERIAL FLOWS, METHOD FOR OPERATING PRESSURE FITTINGS, AND USE

(71) Applicant: Achim Daume, Burgwedel (DE)

(72) Inventor: Achim Daume, Burgwedel (DE)

(21) Appl. No.: 19/114,413

(22) PCT Filed: Sep. 17, 2023
(86) PCT No.: PCT/DE2023/000111

§ 371 Date: Mar. 21, 2025

(30) Foreign Application Priority Data
Sep. 23, 2022 (EP) 22197371.2
Oct. 19, 2022 (DE) 10 2022 003 875.7

(51) Int. Cl. F15D 1/02

(52) U.S. Cl. CPC F15D 1/025

(57) ABSTRACT

A pressure fitting for material flows is presented, comprising a base body with a pressure-reducing unit arranged inside the base body, characterized in that a.) a material interruption is realized between the base body and the pressure-reducing unit, and/or b.) a material interruption is realized between a wall body and the base body arranged inside the wall body.

The invention relates to a pressure fitting for material flows, a method for operating pressure fittings and a use.

In many branches of industry, piping systems are used, for example in chemical plants, refineries and power plants, in which pumps, apparatus and pressure fittings are used in large numbers. These systems are regulated or controlled, with these flowing through very different material flows, and this at very different operating conditions, for example, from 273 degrees Celsius to +640 degrees Celsius and operating pressures from 0 bar to 800 bar. The material flows can be viscous to vaporous and highly alkaline to highly acidic. For the very different material streams, very different materials must also be used

From the state of the art, a wide range of pressure fittings for material streams are known. Based on the above discussions, these consist of a wide range of materials, whereby the pressure fittings must be tested very thoroughly for material safety before use. In particular, cracks, cavities and foreign inclusions can have a significant impact on the respective material quality. Such pressure fittings are tested using ultrasound, magnetic flux determinations, X-rays, dye UV fluorescence measurements and dye penetration tests, although these tests are costly due to the often challenging geometry of the components of such pressure fittings.

The object of the present invention is therefore to provide a pressure fitting that avoids the above-mentioned disadvantages at least to a large extent, so that the time-consuming and thus costly material tests can be significantly reduced.

This problem is solved by a pressure fitting according to claim 1, a method according to claim 20 and a use according to claim 21.

The pressure control valve for material flows (in the sense of the invention, the terms “material flow” and “substance flow”are identical) has a base body with a pressure-reducing unit, characterized in that a.)
between the base body, for example and in particular a pipe, and the pressure-reducing unit, for example and in particular a kind of sleeve, a material interruption is realized, and/or b.) between a wall body, for example in particular a pipe, and the base body arranged in the interior of the wall body, for example and in particular a pipe, a material interruption is realized.

In the context of the invention, the term “material interruption” refers to an interruption of the material flow between the parts listed above, i.e. pressure-reducing unit, base body and wall body. In other words, although these parts are in contact in the context of the invention, either purely mechanically or, for example and in particular, via welds, they are always separate parts and not a single part to which the above parts can be assigned in their respective sections and areas. Thus, these parts do not merge smoothly into one another—as sections and areas of a single part—but are separate from one another in a material sense, so that material interruptions occur in this regard, which, for example, and in particular, can appear in the form of cracks or crevices when the parts merely touch one another, whereby these are of course not real cracks, which would obviously have negative effects on the material of the respective part, but rather these are just these material interruptions between the individual parts (i.e. pressure-reducing units, base body and wall body), which look like cracks or crevices. As a rule, these material interruptions make it easier to carry out the necessary material tests, since the individual parts can be examined separately before they are later assembled into a pressure fitting, thus avoiding complex structures that are generally relatively difficult to examine/test.

It is advantageous if a.) the base body is a molded part and/or b.) the wall body is a molded part, as this helps to save costs when constructing a pressure fitting according to the invention.

Furthermore, it is advantageous if a.) the base body is designed to be free of castings and/or forgings, for example as a pressed part, and/or b.) the wall body is designed to be free of castings and/or forgings, for example and in particular as a pressed part, since such parts can usually be better examined for material defects, for example and in particular by means of ultrasonic measurements.

If the base body is designed as a molded part, many material tests are not necessary, since such molded parts are usually pre-tested for certain material qualities. When designed as a casting-free and/or forging-free base body, the necessary material tests do not cease to apply per se, but they are relatively easy to perform, since castings and/or forgings can often only be tested to a very limited extent; this applies in particular to ultrasonic tests. Nevertheless, in individual cases it may be advisable for the base body to be cast, forged, pressed or drawn.

In the context of the invention, the term “molded parts” refers to components that often correspond to simple geometric shapes, such as, and in particular, pipes, T-pieces, cross-pieces, elbows and Y-pieces, and are often also made of pre-tested material, although the latter criterion is not mandatory. Such molded parts are produced in very high quantities, and as a rule—but not necessarily—are free of castings and/or forgings. Castings and forgings are generally very difficult to test, which particularly applies to ultrasonic measurements.

In this context, it is advantageous, as proven, if the base body molded part and/or the wall body molded part is/are a pipe, T-piece, Y-piece, crosspiece, elbow or ball-shaped piece. These shapes represent the most common and usual shapes of molded parts.

In many cases, the pressure-reducing unit and/or the base body and/or the wall body are advantageously made of one of the following materials, as they have proven effective: pipeline materials, C 22, St. 52, heat-resistant ferritic materials, 16Mo3, 13CrMo44, 10CrMo910, 14MoV63, P91, P92, C22.8, austenitic materials, especially 1.4571, 1.4580, 1.4404, 1.4301, 1.4550, 1.4581, 1.4401, 1.4521, 1.4552, 1.4541, 1.4520, steel casing pipes, PE, PE-X, PP, PVC, copper materials, copper metal alloys, bronzes, aluminum-multicomponent bronze, AB45, ESM, molten steels, CW024A, CW509L, CW610N, CW613N, CW614N, CW617N, CW702R, CW706R, CW717R, CW715R, CW352H, CW354H, CW307G, CW353H, P195TR1, P195TR2, P235TR1, P235TR2, P195GH, P235GH, P265GH, 8MoB5-4, 16Mo3, X11CrMo9-1+I, 13CrMo4-5, X20CrMoV11-1, P355NH, P195GH, P285GH, 16Mo3, P355NH, materials of EN 12952/12953, P215NL, P265NL, P355N, P480NL1, P620Q, P890QH, 8460NH, L290NB, L450QB, L245NB, L555MB, L360MB, L280MB, materials of EN 10208-2, materials of AD2000-HP110R, AD2000-HP120R, AD2000-W2, AD2000-W/6, AD2000-W6/1, AD2000-W6/2, glass, ceramic, plastic, polyethylene, polyamide, polyvinyl chloride, polytetrafluoroethylene, polyoxymethylene.

In this context, it is advantageous, since it has been proven, if the pressure-reducing unit is designed to be free of cast and/or forged parts, in order to avoid major difficulties in material testing, especially in ultrasonic testing. Nevertheless, in individual cases it may be useful for the pressure-reducing unit to be cast, forged, pressed or drawn.

It is of particular advantage, since proven, if a.) the pressure-reducing unit is sleeve-like and designed as an individual part that can be inserted into the base body, and/or b.) the base body is designed as an individual part that can be inserted into the wall body, in order to provide a flexible system for pressure fittings in this way, in order to meet the specific requirements for material, safety and pressure reduction.

To ensure particularly reliable operation, it is advantageous if a.) the pressure-reducing unit is mechanically fixed in the base body, for example and in particular if the pressure-reducing unit is mechanically fixed by means of pin-shaped elements, spot welding, welding, gluing or by means of a thread, and/or b.) the base body is mechanically fixed in the wall body, for example and in particular by means of pin-shaped elements, spot welding, welding or gluing.

Furthermore, it is advantageous, as proven, if the pressure-reducing unit has at least one pressure-reducing material flow opening in order to produce an appropriate pressure reduction for the respective application by means of the dimensioning.

The pressure-reducing unit can advantageously be made of a tough material, such as Cr—Ni steel or martensitic chromium steel, which is more resistant to cavitation. If the pressure-reducing unit needs to be welded to the base body, the weldability must be ensured by selecting a suitable material. It may be necessary to buffer the pressure-reducing unit with a material that is compatible with the weld and the base body.

A.) for secure sealing of the pressure-reducing unit in the base body, the latter is advantageously sleeve-like in design, which, when assembled, is introduced into the interior of the base body and interacts in a force-locking and/or form-locking manner with an inner ramp surface of the base body, and/or b.) for the secure sealing of the base body in the wall body, the base body is inserted in the assembled state into the interior of the wall body and interacts in a force-fitting and/or form-fitting manner with the wall body.

In this context, it is advantageous, since it is proven, if a precompressed sealing element, for example and in particular consisting of graphite, PTFE or a rubber-like material, is arranged inside the base body between the pressure-reducing unit and a further sealing part following the pressure-reducing unit. The precompressed sealing element exerts an additional sealing pressure on the inner ramp surface of the wall body or on the pressure-reducing unit and the sealing part.

In this context, it is advantageous, as proven, if the molded wall body part is a pipe, T-piece, Y-piece, crosspiece, elbow or ball-shaped piece.

As an alternative to the sealing part and sealing element in the pressure fitting according to the invention, it is intended and also advantageous, due to a high level of tightness between the pressure-reducing unit and the base body, that the pressure-reducing unit is held in the base body by means of an interference fit, in particular, as proven, if the pressure-reducing unit and/or the base body are designed as conical or cylindrical surfaces with respect to their interacting surfaces.

In this context, it is advantageous for the particularly secure seals between the base body and the pressure-reducing unit to be achieved that the conical and/or cylindrical surfaces, when viewed in a radial cross-section, have circumferential grooves and/or annular comb profiles.

Furthermore, it is advantageous, since it has been proven, if the press fit is realized by joining the pressure-reducing unit, which has been cooled with respect to the assembly temperature range, which is usually +10° C. to +40° C., with the base body, which has been heated, advantageously with respect to the assembly temperature range, for example and in particular as proven, when the pressure-reducing unit is cooled by means of liquid nitrogen and/or the base body is heated to a temperature in the temperature range from +200° C. to +400° C., in order to be subsequently joined together and thus to achieve a particularly strong joining of the base body and the pressure-reducing unit.

The following are also claimed:

A method for operating pressure fittings, in which a pressure fitting according to the invention is used.

A use of pressure-reducing units, base bodies and wall bodies, as shown in one of the patent claims 1 to 19, in a pressure fitting according to one of the patent claims 1 to 19.

The invention is explained in the following embodiments only by way of example and in a non-limiting manner, wherein:

FIG. 1 is a sketchy cross-sectional representation of various molded parts;

FIG. 2 is a sketchy cross-sectional representation of an embodiment of a pressure-reducing unit together with a sealing part and a precompressed sealing element;

FIG. 3—a schematic cross-sectional view of an embodiment of a base body;

FIG. 4—a schematic cross-sectional view of the parts shown in FIGS. 2 and 3 in the assembled state;

FIG. 5—a schematic cross-sectional representation of the parts shown in FIG. 4 in the assembled state, arranged in a wall body;

FIG. 6—a schematic cross-sectional representation of a further embodiment for cryotechnology (double-walled), shown in FIG. 5;

FIG. 7—a schematic cross-sectional view of a seal-free press fit of the base body and pressure-reducing unit;

FIG. 8—a schematic cross-sectional view of the press fit shown in FIG. 7 and its interacting surfaces.

In FIG. 1, various molded parts 3 can be seen that can function both as a base body 1 and as a wall body 8 in multi-walled pressure fittings.

The pressure fitting for material flows has a base body 1 with a pressure-reducing unit 2, where the base body 1 a.) is a molded part 3 and b.) is designed to be free of castings and forgings.

The base body molded part is a T-piece.

The base body 1 consists of one of the following materials:
pipeline materials, C 22, St. 52, heat-resistant ferritic materials, 16Mo3, 13CrMo44, 10CrMo910, 14MoV63, P91, P92, C22.8, austenitic materials, especially 1.4571, 1.4580, 1.4404, 1.4301, 1.4550, 1.4581, 1.4401, 1.4521, 1.4552, 1.4541, 1.4520, steel casing pipes, PE, PE-X, PP, PVC, copper materials, copper metal alloys, bronzes, aluminum-multicomponent bronze, AB45, ESM, molten steels, CW024A, CW509L, CW610N, CW613N, CW614N, CW617N, CW702R, CW706R, CW717R, CW715R, CW352H, CW354H, CW307G, CW353H, P195TR1, P195TR2, P235TR1, P235TR2, P195GH, P235GH, P265GH, 8MoB5-4, 16Mo3, X11CrMo9-1+I, 13CrMo4-5, X20CrMoV11-1, P355NH, P195GH, P285GH, 16Mo3, P355NH, materials of EN 12952/12953, P215NL, P265NL, P355N, P480NL1, P620Q, P890QH, 8460NH, L290NB, L450QB, L245NB, L555MB, L360MB, L280MB, materials of EN 10208-2, materials of AD2000-HP110R, AD2000-HP120R, AD2000-W2, AD2000-W/6, AD2000-W6/1, AD2000-W6/2.

The pressure-reducing unit 2 is a cast part in this case, but it can also be designed without a cast part.

The pressure-reducing unit 2 is sleeve-like and designed as an individual part that can be inserted into the base body.

The pressure-reducing unit 2 is mechanically fixed in the base body 1, namely by means of pin-shaped elements 9.

The pressure-reducing unit 2 consists of one of the following materials:
pipeline materials, C 22, St. 52, heat-resistant ferritic materials, 16Mo3, 13CrMo44, 10CrMo910, 14MoV63, P91, P92, C22.8, austenitic materials, especially 1.4571, 1.4580, 1.4404, 1.4301, 1.4550, 1.4581, 1.4401, 1.4521, 1.4552, 1.4541, 1.4520, steel casing pipes, PE, PE-X, PP, PVC, copper materials, copper metal alloys, bronzes, aluminum-multicomponent bronze, AB45, ESM, molten steels, CW024A, CW509L, CW610N, CW613N, CW614N, CW617N, CW702R, CW706R, CW717R, CW715R, CW352H, CW354H, CW307G, CW353H, P195TR1, P195TR2, P235TR1, P235TR2, P195GH, P235GH, P265GH, 8MoB5-4, 16Mo3, X11CrMo9-1+I, 13CrMo4-5, X20CrMoV11-1, P355NH, P195GH, P285GH, 16Mo3, P355NH, materials of EN 12952/12953, P215NL, P265NL, P355N, P480NL1, P620Q, P890QH, 8460NH, L290NB, L450QB, L245NB, L555MB, L360MB, L280MB, materials of EN 10208-2, materials of AD2000-HP110R, AD2000-HP120R, AD2000-W2, AD2000-W/6, AD2000-W6/1, AD2000-W6/2.

The pressure-reducing unit 2 has at least one pressure-reducing material flow opening 4.

The pressure-reducing unit 2 is sleeve-like in design, which, when assembled, is introduced into the interior of the base body 1 and interacts in a force-and/or form-fitting manner with an inner ramp surface 5 of the base body 1.

A precompressed graphite sealing element 7 is arranged in the interior of the base body 1 between the pressure-reducing unit 2 and a further sealing part 6 following the pressure-reducing unit 2.

In the case of a multi-walled pressure fitting, the base body 1 is surrounded by at least one wall body 8, which is a.) a molded body 3 and b.) designed to be free of cast and forged parts.

The wall body molded part is a T-piece.

The shape of the wall body 8 is designed to match the shape of the base body 1.

The wall body 8 consists of one of the following materials:

Pipeline materials, C 22, St. 52, heat-resistant ferritic materials, 16Mo3, 13CrMo44, 10CrMo910, 14MoV63, P91, P92, C22.8, austenitic materials, especially 1.4571, 1.4580, 1.4404, 1.4301, 1.4550, 1.4581, 1.4401, 1.4521, 1.4552, 1.4541, 1.4520, steel casing pipes, PE, PE-X, PP, PVC, copper materials, copper metal alloys, bronzes, aluminum-multicomponent bronze, AB45, ESM, molten steels, CW024A, CW509L, CW610N, CW613N, CW614N, CW617N, CW702R, CW706R, CW717R, CW715R, CW352H, CW354H, CW307G, CW353H, P195TR1, P195TR2, P235TR1, P235TR2, P195GH, P235GH, P265GH, 8MoB5-4, 16Mo3, X11CrMo9-1+I, 13CrMo4-5, X20CrMoV11-1, P355NH, P195GH, P285GH, 16Mo3, P355NH, materials of EN 12952/12953, P215NL, P265NL, P355N, P480NL1, P620Q, P890QH, 8460NH, L290NB, L450QB, L245NB, L555MB, L360MB, L280MB, materials of EN 10208-2, materials of AD2000-HP110R, AD2000-HP120R, AD2000-W2, AD2000-W/6, AD2000-W6/1, AD2000-W6/2, glass, ceramics, plastic, polyethylene, polyamide, polyvinyl chloride, polytetrafluoroethylene, polyoxymethylene.

The arrows in the figures show the direction of flow of the respective medium, in this case water. It can be seen how the water flows into the base body 1 and the pressure-reducing unit 2 and, after being redirected, leaves it again at a reduced pressure, in order to then emerge from the base body 1.

In a multi-walled design, the intermediate space 14, for example, can be designed either as a vacuum, low-pressure space, high-pressure space or flooded with a medium; the medium in the intermediate space 14 can be the same medium that originates from the interior of the base body 1 or is supplied to it.

### Regarding Figure 5:

The T-piece has recesses A for the areas 11, 5 and 7. The pressure-reducing part 2 with opening 4 is inserted into the base body 1 in the recess A; then the seal 7 is inserted. Then the ring 4/6 l is inserted. There is a small gap between 4 and 2. The parts 4/6 are pressed against 2 by means of a lifting movement until the gap presses the seal 7. The seal 7, for example made of graphite, is prestressed in the prestressed state so that 7 seals a pressure to be sealed. In the tensioned state (gap approximately zero), 6/4 is fixed, for example, by means of pins or welding/tack welding. The seal 7 is pre-compressed to a density of approx. 1.2 g/cm3 in the non-installed state. During installation, the ring 7 is compressed further to a density of approx. 1.3 to 1.9 g/cm3, depending on the operating pressure. The bore SB should be centered. Part 2 can, for example, be centered at three points around the circumference. The installed parts 2, 5, 7 and 4 are tested for leaks. The outer T-piece 8 is cut lengthwise (two half-shells). 1 is inserted into the half-shell; before that, spacers are fixed by means of welding; the second half-shell is placed on the first shell and welded all around. 1 is fitted with a RE connecting sleeve before assembly.

FIG. 6 shows an example of a special double-walled design for cryogenic technology or toxic material flows.

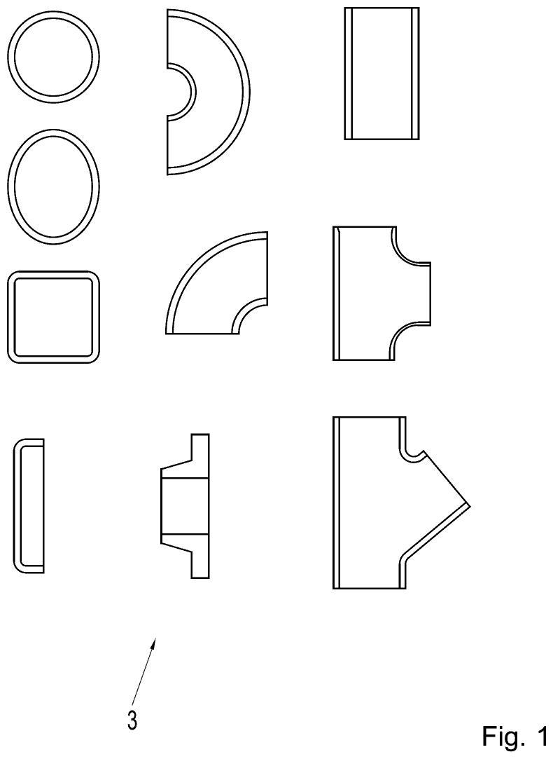

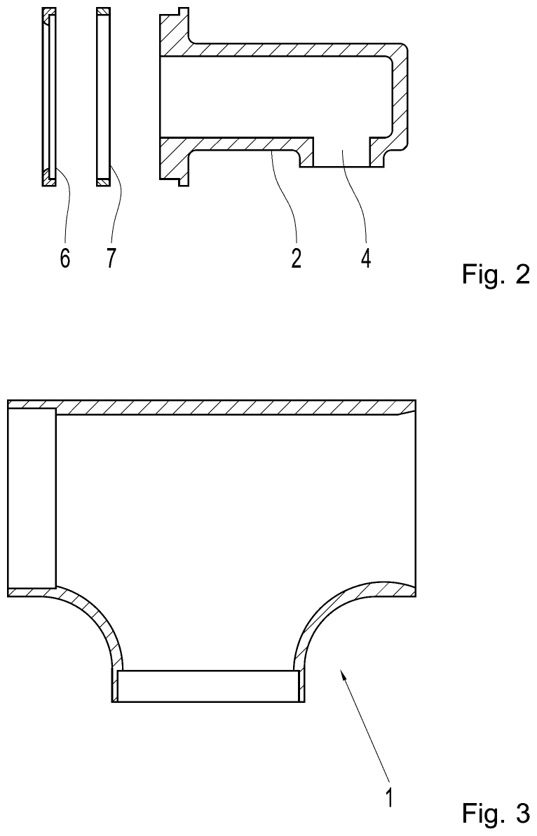

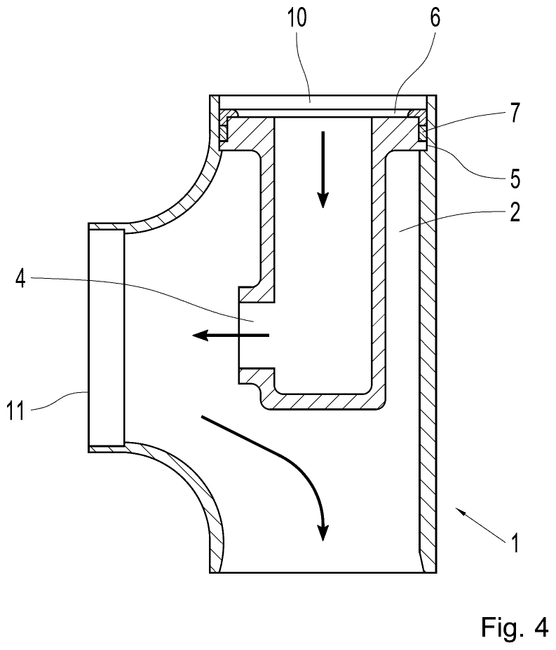

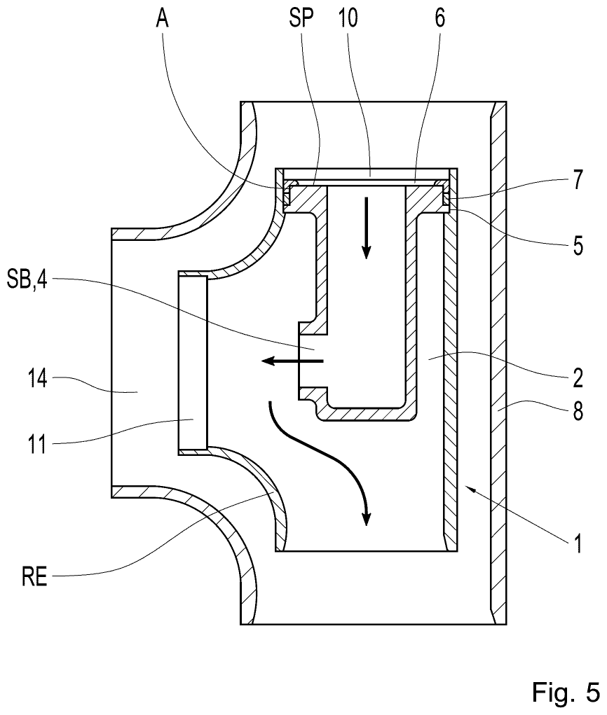

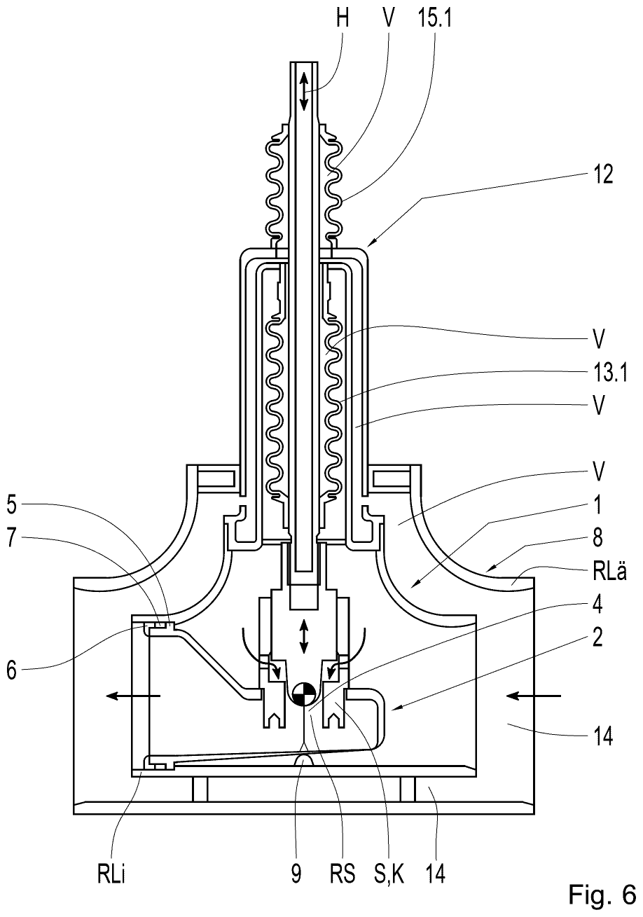

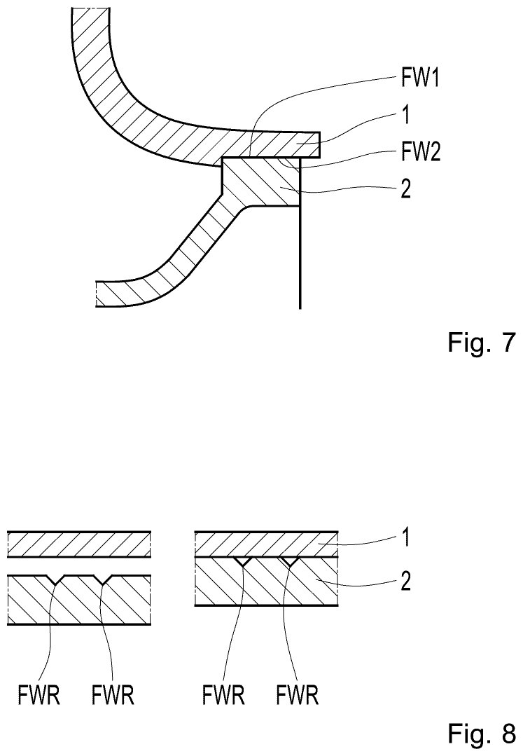

A material flow (arrow) passes through the base body (1). This base body (1) is a pipe (RL) that is connected (e.g. by means of a weld) on both sides. The material flow passes through a throttle body. The stroke of the throttle body changes an annular gap and thus the flow rate. The three-dimensional unit forms a wall that forces the flow to pass through the throttle body (seat S/cone K). The flow rate is controlled according to the stroke position. The wall body 8 encloses the base body 1. The wall body 8 is generally connected to an external line. There is a cavity between the base body 1 and the wall body 8, for example internal pipe RLi and external pipe RLa. This cavity can fulfill several functions: insulation—vacuum, for example cryogenic liquids, toxic substances—warning system. The flow of substances must be prevented from escaping. That is why metal bellows, which move with the stroke, have been used for years, for example 13.1 separation between the substance flow and the vacuum space and 13.2 separation between the vacuum space and the atmosphere. FIG. 6 is about a double-walled fitting being installed in a double-walled system. On the one hand, the double line must be routed through the fitting and must also cover the fitting chamber (insulate or monitor). FIG. 6 shows the outer pipe RLä and the inner pipe RLi. In a fitting, the throttle point is changed from the outside by means of a seat S/cone K and stroke (by positioning the cone K in the seat S; this is known as throttling). The main position is set by moving the valve position. In a double-wall system, a valve must seal the travel adjustment (movement of the spindle) very well (for example, testing with a helium leak test). Such high sealing values can only be achieved with metal bellows, for example 13.1 and 15.1. For example, 15.1 seals atmosphere against vacuum and 13.1 material flow against vacuum. The T-steels used as examples (parts 8 and 1) are preferably compression-molded materials—for example, the austenitic CrNi material 1.4580 can be used. This achieves a high temperature, pressure and chemical resistance to hydrogen embrittlement.

### Regarding FIGS. 7 and 8:

As an alternative to the sealing part and the sealing element in the pressure fitting according to the invention, it is intended and also advantageous, due to a high level of tightness between the pressure-reducing unit 2 and the base body 1, it is envisaged and also advantageous that the pressure-reducing unit 2 is held in the base body 1 by means of an interference fit, in particular, as proven, if the pressure-reducing unit 2 and/or the base body 1 are designed as conical or cylindrical surfaces with respect to their interacting surfaces FW1 and FW2.

In this context, it is advantageous for the particularly secure seals between the base body 1 and the pressure-reducing unit 2 to be achieved by the conical and/or cylindrical surfaces having circumferential grooves (and thus annular material recesses) FWR and/or annular comb profiles (and thus annular material elevations) when viewed in radial cross-section.

Furthermore, it is advantageous, since it has been proven, if the press fit is realized by joining the pressure-reducing unit 2, which has been cooled with respect to the working temperature range of the pressure fitting, with the base body 1, which has been heated with respect to the assembly temperature range, for example and in particular as proven, when the pressure-reducing unit 2 is cooled by means of liquid nitrogen and/or the base body 1 is heated to a temperature in the temperature range from +200° C. to +400° C., in order to be subsequently joined together and thus to achieve a particularly strong joining of the base body 1 and the pressure-reducing unit 2.

With regard to all figures, it can be stated that corresponding material interruptions in the sense described above are realized between the base body 1 and the pressure-reducing unit 2 and between the wall body 8 and the base body 1 in accordance with the invention.

1. Pressure fitting for material flows, having a base body with a pressure-reducing unit arranged in the interior of the base body, wherein a.) a material interruption is realized between the base body and the pressure-reducing unit, and/or b.) between a wall body and the base body arranged in the interior of the wall body a material interruption is realized.

2. Pressure fitting according to claim 1, wherein a.) the base body is a molded part, and/or b.) the wall body is a molded part.

3. Pressure fitting according to claim 1, wherein a.) the base body is designed to be free of cast parts and/or forged parts, and/or b.) the wall body is designed to be free of cast parts and/or forged parts.

4. Pressure fitting according to claim 1, wherein the basic body moulding and/or the wall body moulding is/are a pipe, T-piece, Y-piece, crosspiece, elbow or ball-like piece.

5. Pressure-reducing fitting according to claim 1, wherein the pressure-reducing unit and/or the base body and/or the wall body consists/consist of one of the following materials: pipeline materials, C 22, St. 52, heat-resistant ferritic materials, 16Mo3, 13CrMo44, 10CrMo910, 14MoV63, P91, P92, C22.8,austenitic materials, especially 1.4571, 1.4580, 1.4404, 1.4301, 1.4550, 1.4581, 1.4401, 1.4521, 1.4552, 1.4541, 1.4520, steel casing pipes, PE, PE-X, PP, PVC, copper materials, copper metal alloys, bronzes, aluminum-multicomponent bronze, AB45, ESM, molten steels, CW024A, CW509L, CW610N, CW613N, CW614N, CW617N, CW702R, CW706R, CW717R, CW715R, CW352H, CW354H, CW307G, CW353H, P195TR1, P195TR2, P235TR1, P235TR2, P195GH, P235GH, P265GH, 8MoB5-4, 16Mo3, X11CrMo9-1+I, 13CrMo4-5, X20CrMoV11-1, P355NH, P195GH, P285GH, 16Mo3, P355NH, materials of EN 12952/12953, P215NL, P265NL, P355N, P480NL1, P620Q, P890QH, 8460NH, L290NB, L450QB, L245NB, L555MB, L360MB, L280MB, materials of EN 10208-2, materials of AD2000-HP110R, AD2000-HP120R, AD2000-W2, AD2000-W/6, AD2000-W6/1, AD2000-W6/2, glass, ceramic, plastic, polyethylene, polyamide, polyvinyl chloride, polytetrafluoroethylene, polyoxymethylene.

6. Pressure fitting according to claim 1, wherein the pressure-reducing unit is designed to be free of cast parts and/or forged parts.

7. Pressure fitting according to claim 1, wherein a.) the pressure-reducing unit is sleeve-like and designed as an individual part insertable into the base body, and/or b.) the base body is designed as an individual part insertable into the wall body.

8. Pressure-reducing fitting according to claim 1, wherein a.) the pressure-reducing unit is mechanically fixed in the base body, and/or b.) the base body is mechanically fixed in the wall body.

9. Pressure fitting according to claim 1, wherein the pressure-reducing unit and/or the base body are/is mechanically fixed by means of pin-shaped elements, spot welding, welding or by means of a thread.

10. Pressure fitting according to claim 1, wherein the pressure-reducing unit has at least one pressure-reducing material flow opening.

11. Pressure fitting according to claim 1, wherein a.) the pressure-reducing unit is sleeve-like in design, is introduced into the interior of the base body in the assembled state and interacts in a force-fitting and/or form-fitting manner with an inner run-on surface of the base body, and/or b.) the base body in the assembled state is introduced into the interior of the wall body interacts in a force-fitting and/or form-fitting manner with the wall body.

12. Pressure fitting according to claim 11, wherein a precompressed sealing element is arranged in the interior of the base body between the pressure-reducing unit and a further sealing part following the pressure-reducing unit

13. Pressure fitting according to claim 12, wherein the precompressed sealing element consists of graphite, PTFE or a rubber-like material.

14. Pressure fitting according to claim 11, wherein the pressure-reducing unit is held in the base body by means of an interference fit.

15. Pressure fitting according to claim 14, wherein the pressure-reducing unit and/or the base body are designed as conical or cylindrical surfaces with respect to their interacting surfaces.

16. Pressure fitting according to claim 15, wherein the conical and/or cylindrical surfaces, as seen in radial cross section, have circumferential grooves and/or annular comb profiles.

17. Pressure fitting according to claim 14, wherein the press fit is realized by joining a pressure-reducing unit, which has been cooled with respect to the assembly temperature range of the pressure fitting, to the base body.

18. Pressure fitting according to claim 17, wherein the base body is heated before assembly with respect to the assembly temperature range.

19. Pressure fitting according to claim 17, wherein the pressure-reducing unit is cooled by means of liquid nitrogen and/or the base body is heated to a temperature in the temperature range from +200° C. to +400° C. in order to be subsequently joined together.

20. Method for operating pressure fittings, wherein a pressure fitting according to claim 1 is used.

21. Use of pressure-reducing units, base bodies and wall bodies, as in claim 1, in a pressure fitting according to claim 1.
